(19) United States
(12) Patent Application Publication
(10) Pub. No.: US 2015/0203107 A1
(43) Pub. Date: Jul. 23, 2015

(54) AUTONOMOUS VEHICLE PRECIPITATION DETECTION

(71) Applicant: Ford Global Technologies, LLC, Dearborn, MI (US)

(72) Inventor: Mark Allan Lippman, New Baltimore, MI (US)

(73) Assignee: Ford Global Technologies, LLC, Dearborn, MI (US)

(21) Appl. No.: 14/157,555

(22) Filed: Jan. 17, 2014

(51) Int. Cl. B60W 30/00

(52) U.S. Cl. CPC B60W 30/00

(57) ABSTRACT

A presence of precipitation is determined. At least one attribute of the precipitation is identified. At least one autonomous control action for a vehicle is determined based at least in part on the precipitation.

### BACKGROUND

A vehicle such as an automobile may be configured for autonomous driving operations. For example, the vehicle may include a central control unit or the like, i.e., a computing device having a processor and a memory, that receives data from various vehicle data collection devices such as sensors and generally also external data sources such as navigation information. The central control unit may then provide instructions to various vehicle components, e.g., actuators and the like that govern steering, braking, acceleration, etc., to control vehicle operations without action, or with reduced action, by a human operator.

Vehicle operations, including autonomous and/or semi-autonomous operations may be affected by precipitation. For example, precipitation such as rain, snow, etc., can affect road conditions.

### DRAWINGS

FIG. 1 is a block diagram of an exemplary autonomous vehicle system including monitoring and control of window clearing mechanisms.

FIG. 2 is a diagram of an exemplary process for monitoring and controlling window clearing mechanisms in an autonomous vehicle.

### DETAILED DESCRIPTION

### System Overview

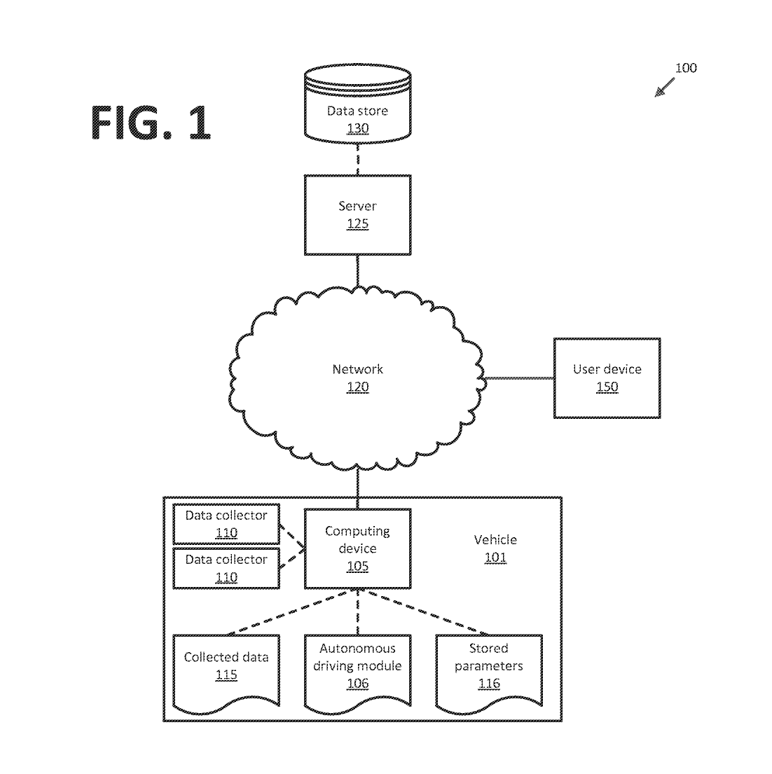

FIG. 1 is a block diagram of an exemplary autonomous vehicle system 100 including precipitation detection and evaluation mechanisms. A vehicle 101 includes a vehicle computer 105 that is configured to receive information, e.g., collected data 115, from one or more data collectors 110 related to precipitation conditions surrounding the vehicle 101, as well as various components or conditions of the vehicle 101, e.g., components such as a steering system, a braking system, a powertrain, etc.

The computer 105 generally includes an autonomous driving module 106 that comprises instructions for autonomously and/or semi-autonomously, i.e., wholly or partially without operator input, operating the vehicle 101. The computer 105 may be configured to account for collected data 115 relating to one or more precipitation conditions in controlling the vehicle 101, e.g., in determining speed, path, acceleration, deceleration, etc. Further, the computer 105, e.g., in the module 106, generally includes instructions for receiving data, e.g., from one or more data collectors 110 and/or a human machine interface (HMI), such as an interactive voice response (IVR) system, a graphical user interface (GUI) including a touchscreen or the like, etc.

Precipitation monitoring and control in the vehicle 101 may be governed by one or more stored parameters 116. By evaluating collected data 115 with respect to one or more stored parameters 116 being used during autonomous driving operations, the computing device 105 can determine whether to take or adjust an action to control the vehicle 101. For example, parameters 116 may indicate, for a particular precipitation or environmental attribute, e.g., a certain rate of rainfall, a likely condition of a type of roadway, e.g., a gravel road, and interstate road, etc., e.g., a likely coefficient of friction, slipperiness, etc. of the roadway. Moreover, parameters 116 may indicate likely conditions of a particular roadway, e.g., a particular segment, e.g., block or blocks of a city street, portion of a highway, etc., for given precipitation conditions, e.g., a certain rate of rainfall, snowfall, etc. Accordingly, detection of one or more attributes of precipitation, e.g., a rate, an amount, and/or a type of precipitation e.g., a certain rate of rainfall, snowfall, etc., can be used in conjunction with parameters 116 specifying a type of road (e.g., paved, gravel, city street, and/or interstate highway, etc.), a topography (e.g., upward or downward inclines), a path (e.g., is a roadway curvy or relatively straight) and other factors (e.g., is the vehicle 101 approaching or traversing a bridge).

A computer 105 may be configured for communicating with one or more remote sites such as a server 125 via a network 120, such remote site possibly including a data store 130. For example, the computer 105 may provide collected data 115 to the remote server 125 for storage in the data store 130 and/or the server may access parameters 116 stored in the data store 130. Accordingly, the server 125 can provide instructions to the vehicle 101 for autonomous or semi-autonomous operation.

### Exemplary System Elements

A vehicle 101 includes a vehicle computer 105 that generally includes a processor and a memory, the memory including one or more forms of computer-readable media, and storing instructions executable by the processor for performing various operations, including as disclosed herein. Further, the computer 105 may include more than one computing device, e.g., controllers or the like included in the vehicle 101 for monitoring and/or controlling various vehicle components, e.g., an engine control unit (ECU), transmission control unit (TCU), etc. The computer 105 is generally configured for communications on a controller area network (CAN) bus or the like. The computer 105 may also have a connection to an onboard diagnostics connector (OBD-II). Via the CAN bus, OBD-II, and/or other wired or wireless mechanisms, the computer 105 may transmit messages to various devices in a vehicle and/or receive messages from the various devices, e.g., controllers, actuators, sensors, etc., including data collectors 110. Alternatively or additionally, in cases where the computer 105 actually comprises multiple devices, the CAN bus or the like may be used for communications between devices represented as the computer 105 in this disclosure. In addition, the computer 105 may be configured for communicating with the network 120, which, as described below, may include various wired and/or wireless networking technologies, e.g., cellular, Bluetooth, wired and/or wireless packet networks, etc.

Generally included in instructions stored in and executed by the computer 105 is an autonomous driving module 106. Using data received in the computer 105, e.g., from data collectors 110, the server 125, etc., the module 106 may control various vehicle 101 components and/or operations without a driver to operate the vehicle 101. For example, the module 106 may be used to regulate vehicle 101 speed, acceleration, deceleration, steering, operation of components such as lights, windshield wipers, etc. Further, the module 106 may include instructions for evaluating precipitation data 115 received in the computer 105 from one or more data collectors 110, and, according to one or more parameters 116, regulating vehicle 101 attributes such as the foregoing based at least in part on the evaluation of collected precipitation data 115.

Data collectors 110 may include a variety of devices. For example, various controllers in a vehicle may operate as data collectors 110 to provide data 115 via the CAN bus, e.g., data 115 relating to vehicle speed, acceleration, etc. Further, sensors or the like, global positioning system (GPS) equipment, etc., could be included in a vehicle and configured as data collectors 110 to provide data directly to the computer 105, e.g., via a wired or wireless connection. Sensor data collectors 110 could include mechanisms such as RADAR, LADAR, sonar, etc. sensors that could be deployed to measure a distance between the vehicle 101 and other vehicles or objects. In the context of the system 100 for monitoring and controlling vehicle 101 windows, sensor data collectors 110 could include known sensing devices such as cameras, laser devices, moisture sensors, etc. to detect vehicle 101 window conditions, such as moisture, frost, ice, dirt, salt, debris, etc.

For example, an interior camera data collector 110 could provide a computer 105 with an image of a vehicle 101 window. One or more attributes, e.g., a type, rate, amount, etc., of precipitation could then be identified based on collected image data 115. For example, a computer 105 may include instructions to use image recognition techniques to determine whether the vehicle 101 window is clean, dirty, frosty, wet, etc., e.g., by comparing a captured image to that of an image representing a clean vehicle 101 window. Additionally, other image processing techniques such as are known could be used, e.g., optical flow to monitor patterns outside of the vehicle 101 when it is in motion. In any event, a pattern in collected image data 115 may be correlated to a particular type, rate, etc. of precipitation.

Alternatively or additionally, a laser sensor data collector 110 could be used to provide collected data 115 for identifying precipitation. For example, low cost laser sensors are known that may be used as laser sensor data collectors 110. For example, a low power, short range laser sensor data collector 101 could be installed in a vehicle 101 dash board so as to detect and identify common materials that would likely interfere with visibility through a vehicle 101 window and/or indicate a type, rate, amounts, etc. of precipitation. Further, such a laser sensor data collector 110 would include a distance measuring capability that would allow the computer 105 to determine if a detected material is on an interior or exterior vehicle 101 window surface. Such determination could be accomplished by measuring the time of flight of the laser signal (i.e., a time from the signal being sent out to its detected return), and knowing the position of the laser sensor with respect to the window. When there is material that collects on the window that would cause a reflection, such as dirt, snow, etc. the time of flight is small and the distance can be calculated. This calculated distance can be compared to a known window location to determine if the window is obscured.

In one implementation of a laser sensor data collector 110, a laser emitter and laser sensor module is mounted inside a vehicle 101 in a fixed position so as to target a fixed position reflective surface (i.e., metal surface) outside the vehicle 101. For example, the laser could be aimed at a part of a vehicle 101 windshield wiper mechanism that is fixed in a position or at a reflective surface specifically located in a place to act as a reflective surface, directing the laser beam back to the sensor included in the data collector 110 inside the vehicle 101. This target reflective surface could be placed so as to provide space between the vehicle 101 window and the target surface. A laser beam may then be initiated and will emit a beam to the target surface that is reflected back to the laser sensor. The laser sensor then provides an electrical signal level based on the laser beam it receives. This continuous feedback of reflective signals provides a constant monitoring of the functionally of the sensor and the window surface.

Further, the use of a Laser Triangulation Sensor data collector 110 allows for the target position to be detected. A beam of light is emitted to a fixed reference target and the resulting signal is based on the position of the beam received by a CCD (charge coupled device) sensor data collector 110. As long as the beam is detected in its reference position on the CCD sensor, it can be determined that no obstacles exist in the laser beam path. If the laser beam moves position or is no longer detected by the CCD, it can be determined that some material has interfered with the path of the laser beam and position of the material may be determined by the beam position received by the CCD sensor. For example, if a frost is built up on the inside or outside of a vehicle 101 windshield, the beam reflected to the CCD sensor will move to a position consistent to being reflected by something at that distance. On the other hand, if snow has built up on the surface of the target the reflected signal will be received in a shorter time, but not as short as that in the case of the window being blocked. In the case that snow also covers the outside of the window, the returned signal may be similar to that in the case of a frosted window.

A laser sensor data collector 110 designed to measure distance is generally a time-based system. The laser transmitter emits a beam to a reference target as discussed above and the amount of time elapsed for the beam to travel from the emitter to the target reflective surface and back to the sensor, indicates the distance between them. If a material breaks the beam path it can be determined at what distance this material is from the sensor. For example if frost is built up on the inside of a vehicle 101 windshield, the distance measured by the laser sensor data collector 110 will be consistent with the known value of distance between the inside of the windshield and the laser sensor module. From such collected data 115 it can be determined that the inside window surface is fogged or frosted, which could be correlated with a precipitation conditions such as mist, rain, or snow.

Because a laser may not generate sufficient reflection from clear water to consistently detect rain, a laser data collector 110 could be used in conjunction with a conventional rain sensor data collector 110 to detect rain. Advantageously, the sensor data collectors 110 disclosed herein, e.g., cameras and lasers, may, as mentioned above, be mounted in an interior of a vehicle 101 thereby avoiding direct contact with external environments and avoiding contact with external dirt, debris, etc. However, external viewing sensor data collectors 110 on the vehicle may also have a view of the vehicle 101 windows, and/or the environment surrounding the vehicle 101, and could use the same types of techniques as described above to determine if a window is obscured. Similarly, such external viewing sensor data collectors 110 could also detect the state of windows on other vehicles that it comes near and report their status to the server 125 via the network 120.

A memory of the computer 105 generally stores collected data 115. Collected data 115 may include a variety of data collected in a vehicle 101. Examples of collected data 115 are provided above, and moreover, data 115 is generally collected using one or more data collectors 110 as described above, and may additionally include data calculated therefrom in the computer 105, and/or at the server 125. In general, collected data 115 may include any data that may be gathered by a collection device 110 and/or computed from such data. Accordingly, collected data 115 could include a variety of data related to vehicle 101 operations and/or performance, as well as data related to environmental conditions, road conditions, etc. relating to the vehicle 101. For example, collected data 115 could include data concerning a type, rate, amount, etc., of precipitation encountered by a vehicle 101.

In general, a type of precipitation may be determined by an individual datum 115 or a combination of sensor data 115. For example, laser sensor data 115 may show little to no external interruption of response due to rain, but a greatly erratic distance response due to snow. Combining laser sensor data 115 with rain sensor data 115 and possibly camera sensor data 115, a type of precipitation can be determined. Further, rain sensor data 115 can generally indicate rain and snow conditions, but may not be capable of differentiating between the two. Rain sensor data 115 combined with external temperature data 115 can help to determine a presence of frozen precipitation as opposed to rain. In the case of snow, laser sensor data 115 may help to show rate of snow fall according to a distance between erratic responses. For example, in high rates of snow fall a distance measurement between snow flake reflections will generally be less than in light snow fall where a laser will detect snowflakes spread over a greater distance.

Moreover, vehicle 101 speed can affect detection of a type and rate of precipitation. In one instance, vehicle 101 speed data would be included as a factor in determining a rate of snow fall. For example, at a 30 miles per hour vehicle 101 speed, laser response to snowfall may appear to be a deceptively high rate of snowfall where the actual snowfall rate is low. Another factor is aerodynamic effects on a vehicle 101 that produces air flow over a vehicle 101 such that the air flow affects the rate at which precipitation makes contact with, or the distance at which precipitation is detected near, the vehicle 101.

A memory of the computer 105 may further store window parameters 116. A parameter 116 generally governs control of a vehicle 101 component related to precipitation possibly affecting navigation and/or control of a vehicle 101. Some examples of parameters 116 and possible values therefor are provided below in Table 1:

TABLE 1

| Parameter | Exemplary Values |
|---|---|
| Type of precipitation | fog, mist, rain, freezing rain, sleet, snow |
| Rate of precipitation | Average volume of water falling per unit |
| | of area and per unit of time |
| Amount of precipitation | Total volume of water falling in a given period |
| | of time |
| Type of road | interstate, multi-lane highway, 2 way |
| | highway, major city street, side street |
| Topography | Flat, moderate, hilly, mountainous, straight, |
| | curvy |
| Outside temperature | In degrees Fahrenheit or Celsius |
| Vehicle speed | In miles per hour or kilometers per hour |

In general, the computer 105 may store a set of default parameters 116 for a vehicle 101 and/or for a particular user of a vehicle 101. Further, parameters 116 may be varied according to a time of year, time of day, etc. For example, parameters 116 could be adjusted so that a given rate or amount of precipitation during daylight might warrant a first (typically higher) speed for a given type of roadway, whereas the same rate or amount of precipitation during darkness might warrant a second (typically lower) speed for the same given type of roadway. Moreover, parameters 116 could be downloaded from and/or updated by the server 125, and may be different for different types of vehicles 101. For example, a given amount of precipitation at a given temperature may indicate a likely coefficient of friction on a roadway. That coefficient of friction may warrant a lower speed for a relatively heavy vehicle 101, but permit a somewhat higher speed for a relatively lighter vehicle 101.

Continuing with FIG. 1, the network 120 represents one or more mechanisms by which a vehicle computer 105 may communicate with a remote server 125. Accordingly, the network 120 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, IEEE 802.11, etc.), local area networks (LAN) and/or wide area networks (WAN), including the Internet, providing data communication services.

The server 125 may be one or more computer servers, each generally including at least one processor and at least one memory, the memory storing instructions executable by the processor, including instructions for carrying out various steps and processes described herein. The server 125 may include or be communicatively coupled to a data store 130 for storing collected data 115 and/or parameters 116. For example, collected data 115 relating to precipitation and/or to road conditions, weather conditions, etc. could be stored in the data store 130. Such collected data 115 from a vehicle 101 could be aggregated with collected data 115 from one or more other vehicles 101, and could be used to provide suggested modifications to parameters 116 being provided to one or more other vehicles 101. To continue this example, collected data 115 could indicate a geographic location of a vehicle 101, e.g., geo-coordinates from a global positioning system (GPS) in the vehicle 101, whereby the server 125 could provide parameters 116 tailored for conditions in a geographic area of the vehicle 101. For example, parameters 116 could be tailored for rain conditions, snow conditions, fog, etc. In general, parameters 116 could be provided from the data store 130 via the server 125. For example, parameters 116 could be updated for a particular vehicle 101 or type of vehicle 101, and then the updated parameters 116 could be provided to the computer 105.

A user device 150 may be any one of a variety of computing devices including a processor and a memory, as well as communication capabilities. For example, the user device 150 may be a portable computer, tablet computer, a smart phone, etc. that includes capabilities for wireless communications using IEEE 802.11, Bluetooth, and/or cellular communications protocols. Further, the user device 150 may use such communication capabilities to communicate via the network 120 and also directly with a vehicle computer 105, e.g., using Bluetooth. Accordingly, a user device 150 may be used to carry out certain operations herein ascribed to a data collector 110, e.g., voice recognition functions, cameras, global positioning system (GPS) functions, etc., in a user device 150 could be used to provide data 115 to the computer 105. Further, a user device 150 could be used to provide a human machine interface (HMI) to the computer 105.

### Exemplary Process

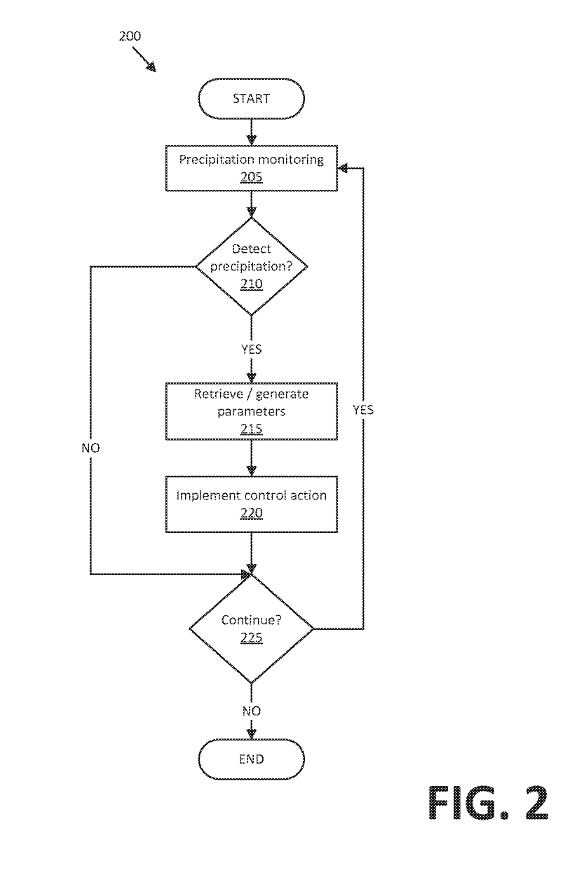

FIG. 2 is a diagram of an exemplary process 200 for monitoring and/or controlling window clearing functions in an autonomous vehicle.

The process 200 begins in a block 205, in which the vehicle 101, generally in an autonomous or semi-autonomous mode, i.e., some or all vehicle 101 operations are controlled by the computer 105 according to instructions in the module 106, performs precipitation monitoring. For example, in an autonomous mode, all vehicle 101 operations, e.g., steering, braking, speed, etc., could be controlled by the module 106 in the computer 105. However, it is also possible that the vehicle 101 may be operated in a partially autonomous (i.e., partially manual, fashion, where some operations, e.g., braking, could be manually controlled by a driver, while other operations, e.g., including steering, could be controlled by the computer 105. In any event, precipitation monitoring may be performed by the computer 105 evaluating collected data 115 relating to precipitation as described above.

Following the block 205, in a block 210, the computer 105 determines whether precipitation is detected. Precipitation may be detected according to a variety of mechanisms, including as discussed above. Alternatively or additionally, precipitation may be detected according to a state of one or more components in the vehicle 101, e.g., windshield wipers are activated, fog lights are activated, etc., and/or presence of precipitation may be communicated from the server 125 according to a location, e.g., geo-coordinates, of a vehicle 101. Further, as discussed above, various mechanisms, including known mechanisms, may be used to determine a type, amount, and/or rate of precipitation.

In the block 215, the computer 105 retrieves one or more parameters 116 relevant to the detected precipitation. Generally parameters 116 are retrieved from a memory of the computer 105, but parameters 116, as mentioned above, may be provided from the server 125 on a real-time or near real-time basis and/or may be periodically updated. In any case, parameters 116 may specify types of precipitation, values related to precipitation, e.g., rates and amounts, and may further specify control actions to be taken with respect to a vehicle 101 based on types and/or values of precipitation. For example, as is known, a possible coefficient of friction of a roadway may be determined based on identifying a type of roadway surface in a parameter 116, along with identifying a type and rate and/or amount of precipitation, along with possibly other values, such as a temperature of a roadway surface and/or a temperature outside the vehicle 101, etc. Accordingly, collected data 115 and parameters 116 may be used to generate collected data 115 indicative of a roadway condition based on precipitation data 115, e.g., a parameter 116 related to a coefficient of friction.

Following the block 215, in a block 220, the computer 105 determines and implements an action or actions in the vehicle 101 based on collected data 115 and parameters 116. For example, collected data 115 may indicate a coefficient of friction data value for a roadway as explained above, whereupon one or more parameters 116 appropriate for the friction value, e.g., parameters 116 governing vehicle 101 speed, required stopping distance, permissible rates acceleration, etc., may be used to determine an action in the vehicle 101. For example, the computer 105 could cause the autonomous control module 106 to reduce a vehicle 101 speed to a certain level based on detected precipitation, e.g., based on one or more of a determined coefficient of friction as just explained.

Moreover, in addition or as an alternative to using a coefficient of friction, other collected data 115 could be compared to one or more parameters 116 and used to determine an action for the vehicle 101, e.g., activation of vehicle 101 windshield wipers, activation of an antilock breaking system in a vehicle 101, detection of a certain type of precipitation and/or rate or amount of the precipitation, e.g., snowfall at a certain rate and/or below a certain temperature, rain at a certain temperature (e.g., close to freezing), rain at the high rate (e.g., where there is a danger of hydroplaning), independent of a determination of the coefficient of friction, etc.

For example, a rate of precipitation, e.g., as determined by current rain sensing technology, generally controls windshield wiper speed in a vehicle 101. If the windshield wiper speed has been set to high speed as determined by rain sensor data 115, a combination of rain sensor data 115, a windshield wiper control mode being set to “automatic” or the like, and windshield wiper speed data 115 can be used to determine potential water pooling and vehicle 101 hydroplaning conditions. Due to the unpredictable nature of vehicle 101 handling control due to a varying coefficient of friction between tires and a road surface, there may be no safe mechanism for a vehicle 101 to operate in an autonomous mode, or a maximum safe speed for autonomous (or semi-autonomous) operation may be relatively quite slow. Accordingly, if previously described conditions of vehicle 101 control and sensed data 115 are current, it may be determined that manual operation is recommended, which recommendation may be communicated to vehicle 101 passengers via a computer 105 HMI or the like. Vehicle 101 passengers could choose to continue at a slow, maximum rate for worst-case conditions in autonomous mode, or could provide input to the computer 105 to assume manual control.

In another example of use of collected data 115, a type of precipitation, e.g., as determined by data collectors 110 using rain sensing technology combined with laser response, is determined to be rain. Moreover, assume that an external temperature at or close to the freezing point of water (i.e., =<32 F or =<0 C) is detected. Other data 115 may be available through information from the server 125 indicating similar conditions. In any event, the data 115 may indicate a potential for an ice-on-road condition. Due to the unpredictable nature of vehicle 101 handling control due to the potential of an unpredictable and/or likely varying coefficient of friction between vehicle 101 tires and a road surface, there may be no safe mechanism for a vehicle 101 to operate in an autonomous mode, or a maximum safe speed for autonomous (or semi-autonomous) operation may be relatively quite slow. If an ice-on-road condition is current, it may be determined that manual operation is recommended, which recommendation may be communicated to vehicle 101 passengers via a computer 105 HMI or the like. Vehicle 101 passengers could choose to continue at a slow, maximum rate for worst-case conditions in autonomous mode, or could provide input to the computer 105 to assume manual control.

Further for example, additional collected data 115 could be used to monitor surrounding traffic, i.e., behavior of one or more other vehicles 101. In combination with precipitation rates and types, other vehicle 101 behavior, e.g., sudden turning acceleration, deceleration, skidding, braking, etc., can be used to determine hydroplane, water pooling and other possible conditions leading to an inconsistent coefficient of friction, i.e., situation where values for a coefficient of friction change significantly on a roadway at a small distance, e.g., foot by foot or yard by yard. In such conditions, as determined by all available data, coefficient of friction calculations may only be useful as a base factor for vehicle 101 control functions, such as maintaining constant speed, acceleration rates and braking rates.

Moreover, in conditions of high precipitation rates, behavior of one or more second vehicles 101 with respect to a roadway lane or lanes can be included as a factor in formulating a control action for a first vehicle 101. For example, where a precipitation condition has been determined and factored into a first vehicle 101 operation, it may also be determined that second vehicles in left and right lanes of a road with three lanes traveling in the same direction, are observed to vary speeds where a constant speed is normally expected. Moreover, it could be determined that vehicles 101 in the center lane have a constant or at least close to constant, consistent rate of travel, than vehicles 101 in surrounding lanes. From this it can be concluded that road conditions, in particular in left and right lanes, have factors causing changes in vehicle 101 control. Likewise, it can be concluded that a vehicle 101 in autonomous mode should be directed to travel in the center lane, and possibly also adding additional following distance from a lead vehicle 101 to compensate for unpredictable yet possible conditions where collected data 115 indicate possible occurrences of water pooling, hydroplane conditions, and, but not limited to, sudden snow covered surfaces.

In general, data 115 relating to traffic flow of vehicles 101 may be used to verify and/or override determinations made with respect to detected precipitation. For example, if traffic flow is determined to be consistent and flowing at a general rate of speed that is higher than a maximum speed determined to be safe in a condition of potential water pooling, hydroplaning, ice on road, etc., then traffic flow may be a factor in determining a vehicle 101 rate of speed in the autonomous module 106. Traffic moving at a slower rate of speed based on potential low levels of coefficient of friction between road and tire can be a hazard due to potential interference with rates of speed at which traffic would otherwise move. In such a case it may be determined that a vehicle 101 rate of speed based on detected traffic flow rates can override maximum speed rates that the autonomous module 106 would otherwise observe based on a potential loss of traction.

In the block 225, which may follow either the block 220 or the block 220, the computer 105 determines whether to continue the process 200. For example, the process 200 ends when autonomous driving operations end. Further, the computer 105 could receive input from a vehicle 101 occupant to end control and/or monitoring of vehicle 101 windows. In any event, if the process 200 is determined to continue, the process 200 returns to the block 205.

### CONCLUSION

Computing devices such as those discussed herein generally each include instructions executable by one or more computing devices such as those identified above, and for carrying out blocks or steps of processes described above. For example, process blocks discussed above are generally embodied as computer-executable instructions.

Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

1. A system, comprising a computer in a vehicle, the computer comprising a processor and a memory, wherein the computer is configured to:
determine a presence of precipitation;
identify at least one attribute of the precipitation;
based on the at least one attribute of precipitation and a measured outside temperature, determine a coefficient of friction of a roadway; and
cause the vehicle to take at least one autonomous control action based at least in part on the determined coefficient of friction.

2. The system of claim 1, wherein the at least one attribute includes at least one of a precipitation type, a precipitation rate, and the precipitation amount.

3. The system of claim 1, wherein the computer is further configured to determine the presence of precipitation and the at least one attribute at least in part based on data collected by data collectors included in or on the vehicle.

4. The system of claim 1, wherein the computer is further configured to determine the presence of precipitation and the at least one attribute at least in part based on data received from a remote server.

5. (canceled)

6. The system of claim 1, wherein the at least one autonomous control action includes at least one of establishing a speed for the vehicle, establishing a stopping distance for the vehicle, braking, and establishing a permissible rate of acceleration for the vehicle.

7. The system of claim 1, wherein the computer is configured to determine the at least one autonomous control action based at least in part on a type of roadway being traversed by the vehicle and a topography of the roadway.

8. A non-transitory computer-readable medium tangibly embodying instructions executable by a computer processor, the instructions including instructions to:
determine a presence of precipitation on a vehicle;
identify at least one attribute of the precipitation;
based on the at least one attribute of precipitation and a measured outside temperature, determine a coefficient of friction of a roadway; and
cause the vehicle to take at least one autonomous control action based at least in part on the determined coefficient of friction.

9. The medium of claim 8, wherein the at least one attribute includes at least one of a precipitation type, a precipitation rate, and the precipitation amount.

10. The medium of claim 8, the instructions further including instructions to determine the presence of precipitation and the at least one attribute at least in part based on one of data collected by data collectors included in or on the vehicle and data received from a remote server.

11. (canceled)

12. The medium of claim 8, wherein the at least one autonomous control action includes at least one of establishing a speed for the vehicle, establishing a stopping distance for the vehicle, braking, and establishing a permissible rate of acceleration for the vehicle.

13. The medium of claim 8, the instructions further including instructions to determine at least one autonomous control action based at least in part on a type of roadway being traversed by the vehicle and a topography of the roadway.

14. A method, comprising:
determining a presence of precipitation on a vehicle;
identifying at least one attribute of the precipitation;
based on the at least one attribute of precipitation and a measured outside temperature, determine a coefficient of friction of a roadway; and
taking at least one autonomous control action in the vehicle based at least in part on the determined coefficient of friction.

15. The method of claim 14, wherein the at least one attribute includes at least one of a precipitation type, a precipitation rate, and the precipitation amount.

16. The method of claim 14, further comprising determining the presence of precipitation and the at least one attribute at least in part based on data collected by data collectors included in or on the vehicle.

17. The method of claim 14, further comprising determining the presence of precipitation and the at least one attribute at least in part based on data received from a remote server.

18. (canceled)

19. The method of claim 14, wherein the at least one autonomous control action includes at least one of establishing a speed for the vehicle, establishing a stopping distance for the vehicle, braking, and establishing a permissible rate of acceleration for the vehicle.

20. The method of claim 14, further comprising determining the at least one autonomous control action based at least in part on a type of roadway being traversed by the vehicle and a topography of the roadway.
